(19) United States
(12) Patent Application Publication
(10) Pub. No.: US 2016/0186291 A1
(43) Pub. Date: Jun. 30, 2016

(54) Continuous Ore Process and Apparatus Using Plasma

(71) Applicants: Michael J. Mills, Las Vegas, NV (US); Dennis Kalnas, Las Vegas, NV (US)

(72) Inventors: Michael J. Mills, Las Vegas, NV (US); Dennis Kalnas, Las Vegas, NV (US)

(21) Appl. No.: 14/805,025

(22) Filed: Jul. 21, 2015

Related U.S. Application Data
(60) Provisional application No. 62/026,896, filed on Jul. 21, 2014.

(51) Int. Cl. C22B 11/02; C22B 4/00; C22B 4/08; C22B 9/14; F27D 3/08; F27B 1/08; F27D 3/00; F27D 9/00; F27D 11/10; C22B 9/10; C21B 11/10

(52) U.S. Cl. CPC C22B 11/02; C22B 9/103; C22B 4/005; C22B 4/08; C22B 9/14; C21B 11/10; F27B 1/08; F27D 3/0033; F27D 9/00; F27D 11/10; F27D 3/08; F27D 2009/0013; F27D 2009/0035

(57) ABSTRACT

A method of processing ore using a plasma arc reactor includes the steps of first determining the content of the ore, modeling the plasma arc reaction for different stoichiometric ratios of ore to candidate reagents, selecting one or more of candidate reagents pre-mixing the selected reagents with the ore at corresponding stoichiometric ratios, and continuously feeding the pre-mixed ore into a plasma arc reactor, and controlling the plasma arc reaction according to the previously modeled conditions.

This application claims the benefit of U.S. Provisional Patent Appl. Ser. No. 62/026,896, filed Jul. 21, 2014, and incorporated herein by reference.

### BACKGROUND OF THE INVENTION

1. Field of the Invention

The invention relates generally to a method for processing ore to recover precious and/or base metals, and to an ore processing reactor for use in the method.

More specifically, the invention relates to improvements to a method of processing ore in a plasma arc reactor or furnace utilizing selected fluxes and/or reducing or oxidizing agents that have been pre-mixed with the ore, and to a continuous feed plasma arc reactor having height-indexed electrodes and integrated cooling ducts.

2. Description of Related Art

Traditional smelting processes use furnaces for melting ore to extract metals. In the case of an induction furnace, the thermal temperature can range from 2,000° F. to 6,000° F. Different fluxes and reducing agents are utilized in such processes to assist in liberation of the metal from the complex ore matrix. The type of reducing agent utilized generally depends on how the metal is bound up in the ore matrix. In certain cases, oxidizing agents may be required instead of reducing agents.

A variation of the traditional smelting process uses a plasma arc rather than induction to heat the ore, in order to obtain higher temperatures. Plasma arc processing temperatures typically range from 5,000° F. to 25,000° F. A plasma arc produces both a high temperature thermal process and an ionized gas. The high temperature ionized gas, commonly referred to as an electromagnetic plasma field, de-molecularizes matter at an atomic level by using the plasma arc to strip molecules of their electrons. This is accomplished without incineration of the ore since combustion does not occur under the conditions of a plasma arc field. Plasma arcs have been used in the United States and other countries for over 60 years.

In one type of conventional plasma arc reactor, the ore is fed in powdered form into the plasma arc field created by a pair of high voltage electrodes. The plasma arc field heats and demolecularizes the constituents of the ore, causing molten material to collect below the electrodes. Because of differences in density between the metal to be recovered from the ore and the remaining materials or “slag,” the molten ore constituents form layers of molten metal and slag that can be separately removed from the reactor through different taps.

Use of a plasma arc reactor to extract platinum group metals (PGMs) from chromite-ore is disclosed in U.S. Pat. No. 4,685,963. This patent uses a process and reactor that are similar to those of the present invention. However, the process lacks provision for modeling the ore processing reactor to optimize selection of reagents, or for controlling the arc length during the reaction. Also, while the plasma arc reactor disclosed in this patent includes a movable torch, movement of the torch is limited to a pivotal movement that does not permit height adjustment or indexing. Still further, while the aforementioned patent discloses inclusion of a cooling panel in the reactor, in order to protect the refractory material that lines the casing, the cooling system does not appear to extend through the casing itself and therefore achieve the rapid cooling necessary to optimize the plasma arc reaction by causing metal vapor to be retained in the reactor rather than vented.

Background information on the use of plasma arc reactors and pre-mixed fluxes or other reagents are disclosed in U.S. Patent Publication Nos. 2011/0274580 and 20140318312. These publications are directed to waste metal recovery or recycling rather than processing or naturally-occurring ores. Waste metal recovery differs from processing of naturally-occurring ores in that the constituents of the feedstock are predictable and do not vary significantly, which eliminates the need to select from among multiple possible reagents for a particular process, but the reagents listed in these publications may also, subject to determination of appropriate stoichiometric ratios, be used in the natural ore processing method of the present invention.

Background information on the modeling of industrial processes is found in U.S. Pat. No. 5,894,806, describes a process for modeling a furnace used for “black liquor reduction” in the paper industry in order to determine “the temperature, velocity and flow path of the hot combustion gases inside the furnace to determine temperature and flow profiles therein; determining the points within the furnace, through observation alone or with modeling, most subject to slagging; and based on this information, determining, for an aqueous treatment fluid, the best droplet size, momentum and reagent concentration, injection location and injection strategy to reach the points in the furnace most affected by slagging.” The present invention also uses modeling of a furnace, but the furnace is a plasma arc furnace used for ore processing rather than a black liquor reduction furnace.

### SUMMARY OF THE INVENTION

The present invention provides an improvement to the conventional method of processing ores or metal complexes to extract metals by plasma arc processing. The improvement involves analysis of the ores and modeling of the reactor in order to select fluxes and/or reducing or oxidizing agents to the powdered ore before feeding the ore into the reactor. The method also involves control of the reaction during processing by indexing of the plasma torch or electrodes, and rapid cooling of the interior of the reactor to prevent escape of metal due to vaporization.

In particular, the method of the present invention may include the steps of:
a. Determining the constituents of the particular ore from which the desired metal is to be extracted;
b. Using process simulation or modeling software to simulate the plasma arc reaction for an ore having the constituents determined in step a;
c. Using the software to simulate the plasma arc reaction when different fluxes and/or reducing/oxidizing agents are added to the ore (this step can also include modeling of different ore constituent variables such as particle shape or size);
d. Selecting a combination of at least one flux and/or reducing/oxidizing agent that optimizes separate of the desired metal from the ore in the simulated plasma arc reaction;
e. Pre-processing the ore to obtain a powder or crushed material;
f. Adding the selected combination of at least one flux and/or reducing/oxidizing agent to the material;
g. Feeding the material with the added flux and/or reducing/oxidizing agent into a plasma arc reactor to separate the desired metal from the ore;
h. Controlling the plasma reaction by moving electrodes in the plasma arc reactor;
i. Continuously cooling the reactor by circulating coolant through passages in a casing of the reactor to achieve rapid cooling and ensure that vaporized metal is retained in the reactor; and
j. Periodically removing the desired metal and slag from the plasma arc reactor.

In order to implement the above-described method, the plasma arc torch is preferably in the form of a pair of high voltage electrodes that can be raised and lowered into the reactor. The control variables for the torch consist of torch depth into the reactor or the distance of the plasma from the molten metal pool.

Both the reactor and the torch are cooled during operation to eliminate the possibility of melting during operation. These cooling and control systems are critical so redundant systems like pumps are designed into the equipment.

In order to increase cooling rate, the cooling system may include ducts or passages that are formed within the casing of the reactor, and extend through each of the casing sections. The use of a rapid cooling system in the casing of the reactor increases the temperature gradient as one moves away from the center-line of the plasma plume (which can reach temperatures of 10,000 Degrees Celsius), and helps ensures that vaporized metal is retained in the reactor and does not exit through the venting system. This adds to the metal recovery rate and improves efficiency.

The reactor is designed is such a way as to allow the tapping of liquid metal and slag at different heights. The feed rate and ore composition determine how often the reactor is tapped. After tapping, the reactor fills up again and the tapping process is repeated. When tapped the molten metal flows through a spout and into a ladle. The ladle is maneuvered into position that allows the ladle to pour the metal into anode molds, which are then placed into electro-refining cells (Moebius Cell) cells and electro-refined. This allows collection of the target metal.

Although a specific plasma arc reactor is illustrated herein, those skilled in the art will appreciate that the method of the invention may be utilized with continuous feed plasma arc reactors other than the preferred reactor, so long as the reactor is capable of reaching desired temperatures for the ores to which the method is applied, and of receiving feedstock in the form of a pre-mixture of the ores to be processed and reagents such as fluxes, reducing agents, or oxidizing agents.

Those skilled in the art will also appreciate that the invention is not limited to a particular reagent or combination of reagents, and that the specific reagents used will depend on the composition of the ore to be processed and the parameters of the process and the reactor, as determined by the method of the invention. Furthermore, the method of the invention may be applied both precious and base metals, and to ores and other materials that can be crushed or otherwise converted into a powder from which metal is to be extracted or liberated.

Similarly, those skilled in the will appreciate that the plasma gas may be any inert gas or combination of gases, and that the plasma arc can be a DC, AC, or RF arc. Each of these variations can be included in the model used to select the reagents, based on the constituents of the ore to be processed.

Since most all elements in nature are oxides, extraction of the metal generally involves removal of the oxide to be left with the target elemental metal. The process is particularly suited to extraction of gold, platinum and silver, but the process also can be used to obtain other precious metals such as platinum group metals (PGM's), which are platinum, osmium, iridium, ruthenium, rhodium and palladium. This process also can be used to obtain other base metals such as, by way of example and not limitation, Ti, V, Cr, Mn, Fe, Co, Ni, Cu, Zn, Y, Sr, Zr, Cd, W, and Pb.

Software capable of simulating or modeling ore processing reactions, including analysis of the effects of ore pre-processing on the reactions, is currently widely used in the ore processing industry. Suitable process simulation software that can be applied to the process described in the present application include Apex™, Chemcad™, and Prosim™. The software must be adapted to analyze not only the effects of the plasma arc field on the ore, but also on a combination of the ore and various fluxes and/or reducing or oxidizing agents. Those skilled in the art of ore processing will be able to select whether reducing or oxidizing agents are required, and candidate fluxes, and therefore input appropriate candidates to the software for analysis.

### BRIEF DESCRIPTION OF THE DRAWINGS

FIG. 1 is a perspective view of a plasma arc reactor for use in connection with the ore processing method of a preferred embodiment of the invention.

FIG. 2 is a front view of the plasma arc reactor of FIG. 1.

FIG. 3 is a cross-sectional side view of the plasma arc reactor of FIG. 1.

FIG. 4 is a cross-sectional view of a casing section for the reactor of FIG. 1, showing details of the cooling passages.

### DETAILED DESCRIPTION OF THE PREFERRED EMBODIMENTS

Throughout the following description and drawings, like reference numbers/characters refer to like elements. It should be understood that, although specific exemplary embodiments are discussed herein there is no intent to limit the scope of present invention to such embodiments. To the contrary, it should be understood that the exemplary embodiments discussed herein are for illustrative purposes, and that modified and alternative embodiments may be implemented without departing from the scope of the present invention.

In the following description, a preferred plasma arc reactor is described first, followed by a detailed description of an ore processing method that uses the preferred reactor, but that may also use plasma arc reactors other than the preferred reactor.

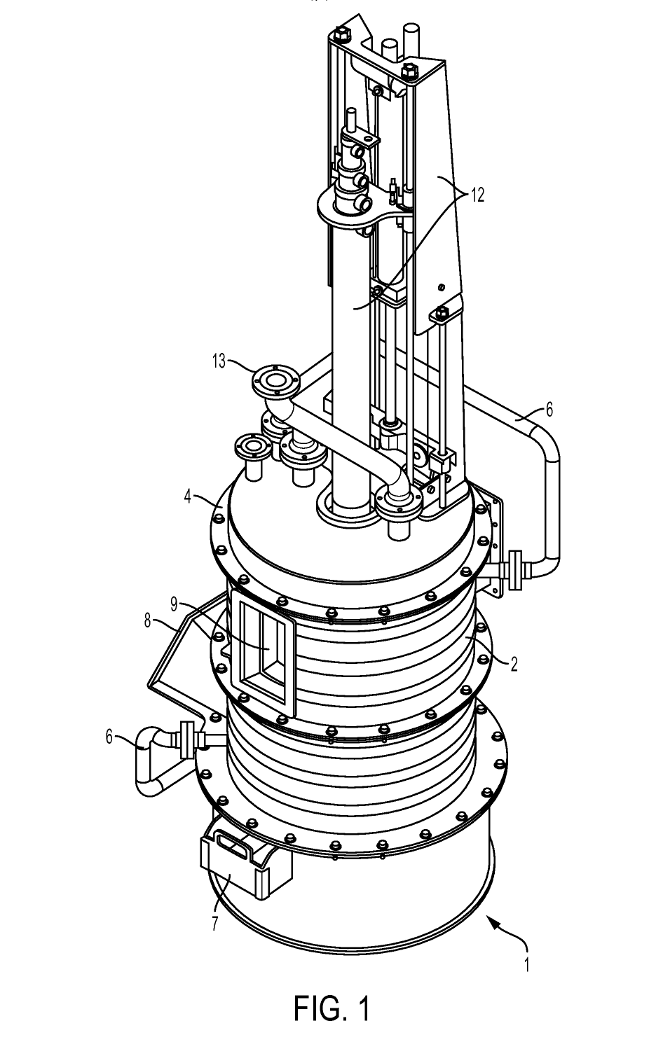

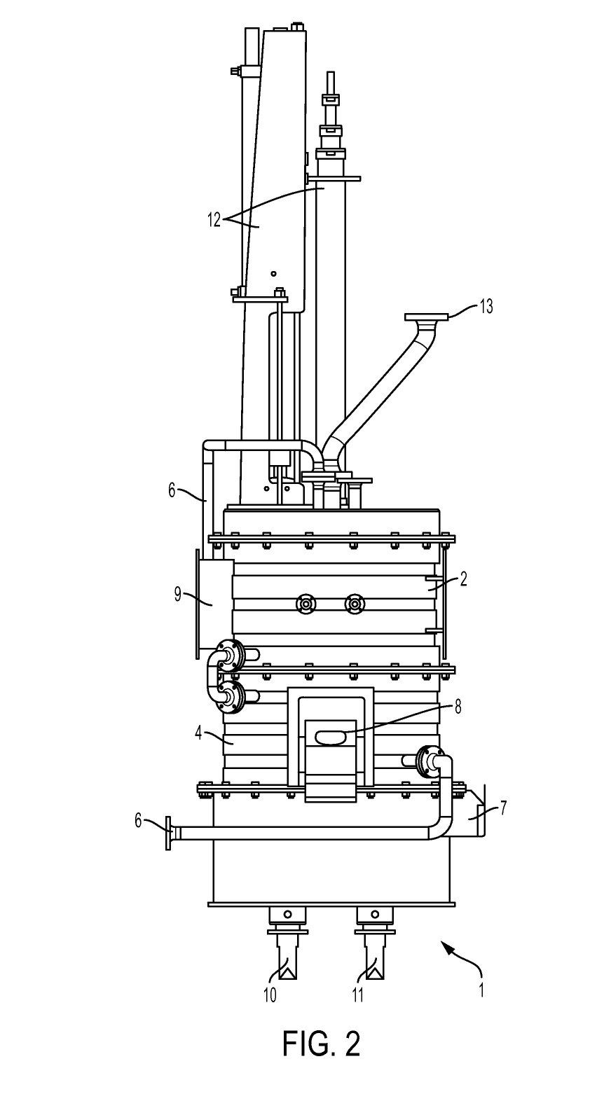

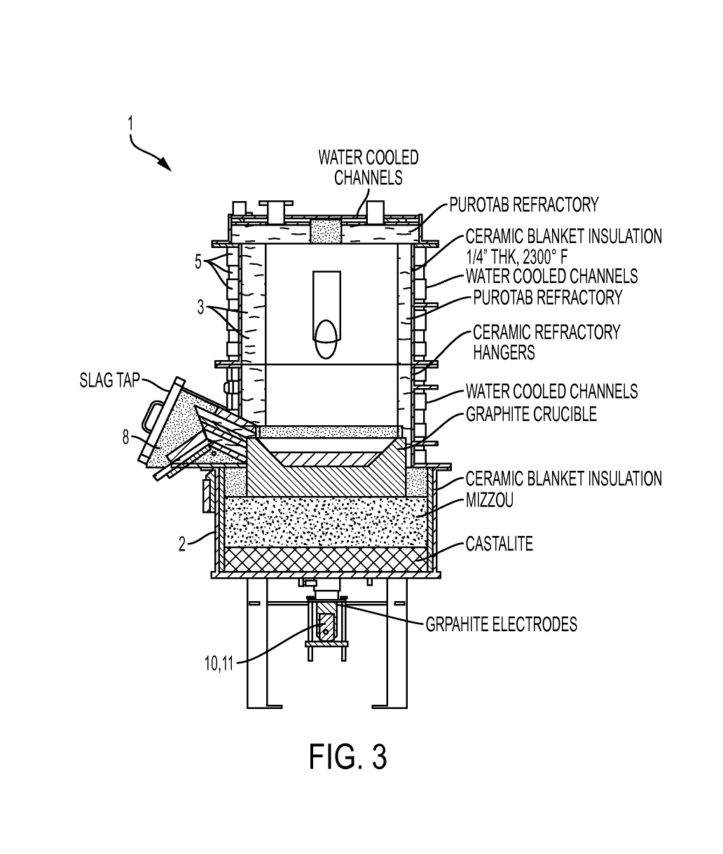

FIGS. 1-4 show an example of a plasma arc reactor 1 that may be used in the method of the invention. The reactor 1 includes a casing 2 having an inner refractory lining 3 and an outer shell 4 in which is formed one or more continuous helical passages or channels 5 for the circulation of coolant. The inner refractor refractory material may, by way of example, be Purotab™, while the outer shell may be made of graphite. At the base of the reactor 1 are additional refractory layers, for example a Mizzou™ layer and a lower refractory layer made of a material such as Castalite™. The coolant channels 5 are mutually connected and supplied with coolant via coolant pipes 6. The coolant may be water that is circulated through a heat exchanger before return to the furnace.

Both the reactor and the torch are cooled during operation to eliminate the possibility of melting during operation. These cooling and control systems are critical so redundant systems like pumps (not shown) are preferably designed into the equipment. An example of this is a cooling water pump for the reactor jacket, which may include both a primary centrifugal pump and a gas-powered backup pump, each connected to the coolant pipes 6, so that if electrical power is lost during operation of the reactor, the operator can still start the gas backup pump to continue to cool the reactor. The control system has software to control the torch operation and various support systems.

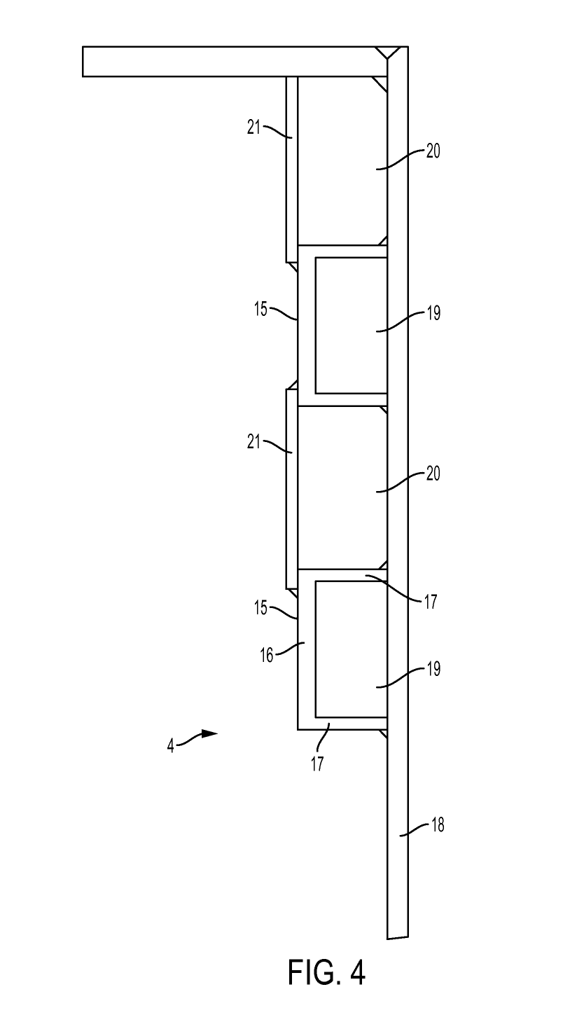

The casing 2 is made up of multiple sections, with the cooling passages or channels 5 being preferably formed in the outer shell 4, as best shown in FIG. 4, to provide rapid cooling around the entire periphery of the reactor. As shown in FIG. 4, the passages may be formed by attaching a helical structure 15 having a u-shaped cross-section with a base 16 and sides 17 to a sidewall 18 and thereby form a first helical cooling channel 19, the individual coils of the helical structure being spaced to form a second cooling channel 20 that is closed by a cover plate 21. The use of a rapid cooling system in the casing 2 of the reactor 1 increases the temperature gradient as one moves away from the center-line of the plasma plume (which can reach temperatures of 10,000 Degrees Celsius), and helps ensures that vaporized metal is retained in the reactor and does not exit through the enting system. This adds to the metal recovery rate and improves efficiency.

Formed in the casing 2 are respective openings or taps, including tap 7 for removing molten metal from a lower section of the casing, tap 8 for removing slag from a center section of the casing, and vent opening 9, which may be connected to an exhaust flue or chimney (not shown). During processing, a molten metal pool is maintained in the lower section of the casing 2 to increase the resonance time in the reactor and enhance the efficiency of the ore conversion to metal. As in traditional furnaces used in the iron industry, the slag and metal may be tapped off to pour into molds to form ingots. Alternatively, the molten metal may be sent to a quench system to produce pellets similar to corn flakes when the hot metal is dripped into cold water.

In the illustrated reactor, tap 7 is preferably made of a clay material and is replaced after tapping, so that when the reactor fills up again, the tapping process is repeated. When tapped, the molten metal flows through a spout and into a ladle. The ladle is supported by a crane and maneuvered into position that allows the ladle to pour the metal into molds. These mold are called anode molds and weigh about 50 to 100 pounds each depending upon metal thickness. These are then placed into electro-refining cells (Moebius Cell) cells and electro-refined.

The high voltage electrodes 10 and 11 are movably supported by an indexing mechanism 12 for raising and lower the electrodes 10,11 in order to control the arc. The indexing mechanism may include a hydraulic ram or any other controllable raising and lowering mechanism capable of rapid movement so as to be able to respond to changes in the arc. The distance traversed by the arc is initially set at a minimum to enable establishment of the arc, and then increased and controlled by feedback to maintain a desired arc during processing of the ore.

A preferred reactor includes a 1.0 MW plasma torch that has a range of power (voltage and current) inside the reactor. The control variables for the torch consist of torch depth into the reactor or the distance of the plasma from the molten metal pool. Transfer gases may include Argon, Nitrogen, Helium, and other inert gases, which can also be mixed at varying compositions. The motive gas flow rate normally starts around 6 standard cubic feet per minute (6 scfm).

The pre-mixed ore is continuously fed through a feeder tube 13 connected to a continuous feeder The continuous feeder may, by way of example and not limitation, be a continuous auger feeder (not shown). The pre-mixture of flux and ore is fed into the reactor at various flow rates. An exemplary basic plasma system may process 10 tons per day, but this can range from as low as pounds per hour to as high as 100 to 500 tons per day.

An ore processing method according to a preferred embodiment of the invention will now be described. The first step of the preferred method is to analyze the ore to be processed, by obtaining a detailed chemical composition of the ore. This may be accomplished through the use of conventional or commercially-available ore assay packages.

Once an understanding of the metals and oxides present is obtained, the next step is to match the appropriate flux to the ore. The word flux comes from the Latin root meaning “to flow”. Chemical fluxes are classified into four groups:
1. Oxidizing fluxes: these introduce oxygen and are used in removing oxidizable metals or impurities. Potassium Nitrate (KNO₃) and Sodium Nitrate (NaNO₃) are the best of this group.
2. Reducing fluxes: These fluxes have an affinity for oxygen and will remove it from ores by reacting chemically with oxides that are already present. Examples of this type of flux are; charcoal, sugar, dry sodium carbonate (Na₂CO₃), argol, dry potassium carbonate (K₂CO₃), Potassium cyanide (KCN), phosphorus and lithium. Others also include; coke, wheat flour, starch, hard coal, soft coal and cream of tartar, etc.
3. Neither reducing or oxidizing fluxes: These fluxes act as covers to neutralize the oxidizing or reducing effects of the products of combustion during melting. They also dissolve and flux off any oxides that may be present. The most common of these are borax (Na₂B₄O₇), boric acid (H₃BO₃), fluorspar (CaF₂) and powdered glass (SiO₂).
4. Tougheners: These are used in purifying gold that is almost pure already.

Examples include ammonium chloride (NH₄Cl) and salt (NaCl).

Any one of these reagents, or any combination thereof, may be considered as candidate reagents in the method of the invention, depending on the constituents of the ore to be processed and the parameters of the ore processing reaction and reactor.

Moreover, it will be appreciated that the list of reagents presented above is exemplary only, and that any one of these chemicals can be added in a percentage range from 0.1% or less to 99%. In addition, one can use a single chemical as a flux, such as borax, or one can create a flux by mixing chemicals, such as the flux for Rhyolite ore (Si and Al), which includes six chemicals as follows: 50 g PbO+5 g Na₂B₄O₇+3 g flour+25 g Na₂CO₃+1 g SiO₂+1 g CaF. Although those skilled in the art will be able to select candidate reagents and likely ratios for the general type of ore to be processed, the exact mixture is further refined by modeling the reactions that take place in a simulation of the plasma arc reactor.

An example of a reduction process involves iron oxide and its derivatives, which are as follows:
1. Fe
2. FeO
3. Fe₂O₃
4. Fe₃O₄
   In order to implement the flux selection step, the process is modeled with a candidate reducing agent premixed with the iron oxide and derivatives according to a selected stoichiometric ratio. For example, the candidate reducing agent may be coal, which helps with the reduction and flow-ability of the slag part of the process.

The process simulation used to determine appropriate reagents and ratios of reagent to ore may take into account any one or more of the following process variables or parameters, the feed rate for the mixture (and/or how often the metal is tapped), ore constituent variables such as particle shape or size, arc temperatures determined by control of the electrode indexing mechanism, and the reduction or oxidizing reactions for the ore to be processed, as well as any other process variables or parameters known to those skilled in the art of ore processing or metallurgy. For the example of iron oxide and its derivatives, the reduction reactions are as follows:
1. Fe (s)->Fe (s)
2. 2FeO(s)+C(s)->2Fe(s)+CO₂(g)
3. 2Fe2O3(s)+3C(s)->4Fe(s)+3CO2(g)
4. Fe3O4(s)+2C(s)->3Fe(s)+2CO2(g)

Upon selection of a suitable reducing agent and/or other reagents, the reagents are mixed with the ore and the premixed material is fed into the plasma reactor by a continuous auger feeder. This feed is in accordance with the appropriate resonance time required in the reactor.

The ore and flux mixture being fed into the reactor enters on an inclined angle allowing for the material to flow into the plasma arc near the surface of the molten pool of material. This entrance into the plasma plume allows pre melting before the material enters into the molten pool of metal and slag. The resonance time is relatively quick. The plasma arc root (the point where the plasma meets the molten pool) is about 10,000 Celsius or 18,032 Fahrenheit. This temperature gradient dramatically decreases as one moves away from the centerline of the plasma arc. The downward force of the plasma arc provides movement in the molten pool to provide some mixing component.

During processing, software is used to control both the current applied to the electrodes, and the electrode height. In addition, continuous cooling is maintained, for example by pumping water through the passages in the casing of the reactor if such passages are provided.

It will be appreciated by those skilled in the art that the pre-mixture of ore and reagents may be further adjusted based on actual performance or results of the processing reaction.

As an alternative to the above-described reactor, which has metal and slag taps at various levels to allow for the removal of the slag and molten metal, one could use an overflow style crucible, in which the primary driving force is gravity allowing the molten metal to spill over the cavity in the bottom of the crucible. This molten metal flows down a short exit trough to the cooling section of the reactor. This area is uninsulated and allowed the rapid cooling of the flue gas. This was important to ensure vaporized metal remained in the reactor thus collecting in the metal fraction of the output.

Although the invention has been explained in relation to its preferred embodiments, it is to be understood that many other possible modifications and variations can be made without departing from the spirit and scope of the invention as hereinafter claimed.

What is claimed is:

1. A continuous ore processing method, comprising the steps of:
a. determining the constituents of the particular ore from which the desired metal is to be extracted;
b. using process simulation or modeling software to model the plasma arc reaction for an ore having the constituents determined in step a and one or more candidate reagents, said reagents including at least one of a flux and an reducing or oxidizing agent;
c. using the software to simulate the plasma arc reaction when different fluxes and/or reducing/oxidizing agents in different stoichiometric ratios are added to the ore;
d. selecting a combination of at candidate reagents and corresponding stoichiometric ratios that optimize separation of the desired metal from the ore in the simulated plasma arc reaction;
e. pre-processing the ore to obtain a powder or crushed material;
f. adding the selected combination of at least one flux and/or reducing/oxidizing agent to the material;
a. feeding the material with the added flux and/or reducing/oxidizing agent into a plasma arc reactor to separate the desired metal from the ore;
b. controlling the plasma reaction by moving electrodes in the plasma arc reactor;
g. continuously cooling the reactor to achieve rapid cooling and ensure that vaporized metal is retained in the reactor; and
h. removing the desired metal from the plasma arc reactor.

2. A continuous ore process method as claimed in claim 1, wherein step g includes the step of circulating coolant through passages in a casing of the reactor.

3. A continuous ore processing method as claimed in claim 1, step I includes the step of vertically moving the electrodes towards and away from a pool of molten material in the reactor to control the plasma arc.

4. A continuous ore process method as claimed in claim 1, wherein the metal to be extracted is selected from gold, silver, and a platinum group metal.

5. A continuous ore processing method as claimed in claim 1, wherein said candidate reagents are oxidizing fluxes.

6. A continuous ore processing method as claimed in claim 5, wherein said oxidizing fluxes are selected from potassium nitrate (KNO₃) and sodium nitrate (NaNO₃).

7. A continuous ore processing method as claimed in claim 1, wherein said candidate reagents are reducing fluxes.

8. A continuous ore processing method as claimed in claim 7, wherein said reducing fluxes are selected from charcoal, sugar, dry sodium carbonate (Na₂CO₃), argol, dry potassium carbonate (K₂CO₃), Potassium cyanide (KCN), phosphorus, lithium, coke, wheat flour, starch, hard coal, soft coal and cream of tartar.

9. A continuous ore processing method as claimed in claim 1, wherein said candidate reagents are neither reducing nor oxidizing fluxes.

10. A continuous ore processing method as claimed in claim 9, wherein said candidate reagents are selected from borax (Na2B4O7), boric acid (H3BO3), fluorspar (CaF2) and powdered glass (SiO2).

11. A continuous ore processing method as claimed in claim 1, wherein said candidate reagents are tougheners used in purifying gold.

12. A continuous ore processing method as claimed in claim 11, wherein said tougheners are selected from ammonium chloride (NH4Cl) and salt (NaCl).

13. A plasma arc ore-processing reactor having a continuous feed and rapid cooling, comprising:
a casing including a lower section having a metal tap, a central section having a slag tap, and a vented upper section;
a pair of high voltage electrodes for creating a plasma arc;
a mechanism for vertically moving the electrodes in order to control an arc length or position;
a continuous feed mechanism for feeding a pre-mixture of ore and reagents into the casing for exposure to the plasma arc; and
a cooling system that includes coolant passages extending through the casing of the reactor,
wherein the plasma arc causes a pool of molten metal to collect in the lower section of the casing for removal through the metal tap, and a layer of slag to form above the pool of metal for removal through the slag tap.

14. A plasma arc ore-processing reactor as claimed in claim 13, wherein the mechanism for moving the electrodes is a hydraulic ram.

15. A plasma arc ore-processing reactor as claimed in claim 13, wherein the coolant passages extend helically between inner and outer walls of the casing, said inner walls supporting a refractory material.

16. A plasma arc ore-processing reactor as claimed in claim 13, wherein a coolant in the passages is water.

17. A plasma arc ore-processing reactor as claimed in claim 13, wherein the continuous feed mechanism is a continuous auger feed.
